(19) United States
(12) Patent Application Publication
(10) Pub. No.: US 2011/0178192 A1
(43) Pub. Date: Jul. 21, 2011

(54) COATING FORMULATION FOR EXPANDABLE PARTICULATE STYRENE POLYMER

(75) Inventors: Andreas Keller, Bohl-Iggelheim (DE); Olaf Kriha, Ludwigshafen (DE); Wolfram Husemann, Neustadt (DE); Klaus Hahn, Kirchheim (DE); Bernhard Schmied, Frankenthal (DE); Michael Riethues, Ludwigshafen (DE)

(73) Assignee: BASF SE, Ludwigshafen (DE)

(21) Appl. No.: 12/672,352

(22) PCT Filed: Aug. 8, 2008
(86) PCT No.: PCT/EP2008/060444

§ 371 Date: Feb. 5, 2010

(30) Foreign Application Priority Data
Aug. 9, 2007 (EP) 07114072.7

(51) Int. Cl. C08J 9/224; C08L 25/06; C08L 91/00

(52) U.S. Cl. 521/57; 106/243

(57) ABSTRACT

A coating formulation intended for expandable particulate styrene polymer and comprising
(A) from 10 to 90% by weight of a tristearyl ester whose melting point is in the range from 60 to 65° C.,
(B) from 10 to 90% by weight of a triglyceride of a hydroxy-C₁₆-C₁₈ oleic acid whose melting point is in the range from 70 to 95° C., and also
expandable particulate styrene polymer which has at least one coating composed of said coating-composition formulation.

The invention relates to a coating formulation for expandable particulate styrene polymer.

To permit problem-free conveying of expandable polystyrene (EPS), and to reduce the level of electrostatic charging of the prefoamed particulate polystyrene foam, the particulate EPS is generally coated with an antistatic agent. Unsatisfactory antistatic properties often result from abrasion or wash-off of the coating composition from the surface of the particulate material. The coating with the antistatic agent can moreover lead to caking of the particulate material and to poor flow behavior.

EP-A 470 455 describes bead-shaped antistatic expandable styrene polymers with a coating composed of a quaternary ammonium salt and of fine-particle silica, where these feature good flow behavior.

DE 195 41 725 C1 describes expandable styrene bead polymers with reduced water absorption capability which have been provided with a coating which comprises, alongside glycerol tristearate, zinc stearate, and glycerol monostearate, from 5 to 50% by weight, based on the weight of the coating, of a hydrophobic silicate.

DE 195 30 548 A1 describes expandable styrene bead polymers with reduced water absorption capability which have been provided with a coating which advantageously also comprises an anticaking agent based on a hydrophobic silicate, alongside from 10 to 90% by weight, based on the weight of the coating, of coconut oil or paraffin oil.

GB 1,581,237 describes inter alia the use of castor wax (hydrogenated castor oil, HCO) as coating composition for expandable polystyrene, in order to improve deformability and the quality of the foam moldings after sintering of the prefoamed particulate EPS.

Good mechanical properties, in particular flexural strengths and compressive strengths, can generally be achieved with the coating-composition formulations described only if markedly longer demolding times, in particular longer depressurization times, are accepted in the slab-production or foam-production process.

It was therefore an object of the present invention to eliminate the disadvantages mentioned and to find a coating-composition formulation which can be used for expandable particulate styrene polymer and which exhibits less tendency toward caking of the particulate material during the prefoaming process, and which permits rapid processing of the prefoamed and particulate material with a low level of static charging, to give foam moldings with good mechanical properties.

Accordingly, a coating-composition formulation has been found for expandable particulate styrene polymer, and comprises

(A) from 10 to 90% by weight of a tristearyl ester whose melting point is in the range from 60 to 65° C.,
(B) from 10 to 90% by weight of a triglyceride of a hydroxy-C₁₆-C₁₈ oleic acid whose melting point is in the range from 70 to 95° C.

The coating can comprise further antistatic agents and/or coating auxiliaries, or can be applied to further coatings using other coating compositions.

One preferred coating-composition formulation for expandable particulate styrene polymer is essentially composed of

(A) from 20 to 80% by weight of a tristearyl ester whose melting point is in the range from 60 to 65° C.,
(B) from 15 to 60% by weight, in particular from 20 to 45% by weight, of a triglyceride of a hydroxy-C₁₆-C₁₈ oleic acid whose melting point is in the range from 70 to 95° C.,
(C) from 5 to 30% by weight of a hydrophilic or hydrophobic silicate, or zinc stearate,
(D) from 0 to 40% by weight, in particular from 10 to 50% by weight, of a glycerol monoester of a C₁₆-C₁₈ fatty acid,
(E) from 0 to 10% by weight of a quaternary ammonium salt, sulfonium salt or ethylenebisstearyldiamide, the entirety of components (A) to (E) being 100% by weight.

Components (A) and (B) are natural products which typically comprise minor amounts of impurities and more particularly may also comprise mono-, di- and triglycerides of other acids.

It is preferable that the coating-composition formulation comprises glycerol tristearate (GTS) or tristearyl citrate (CTS) as tristearyl ester (A).

It is preferable that triglycerides of monohydroxy-C₁₆-C₁₈ alkane acids, in particular hydrogenated castor oil (HCO, castor wax), are used as triglyceride of a hydroxy-C₁₆-C₁₈ oleic acid (B).

It is preferable that glycerol monostearate (GMS) is used as the glycerol monoester of a C₁₆-C₁₈ fatty acid (D).

The invention further provides expandable particulate styrene polymer which has at least one coating composed of the coating-composition formulations described above.

Preferred expandable particulate styrene polymer has

(I) a first coating composed of from 0.1 to 2% by weight, based on the expandable styrene polymer, of at least one compound from the group comprising glycerol monostearate, glycerol distearate, zinc stearate, quaternary ammonium salts, sulfonium salts, and ethylenebisdiamides, and
(II) a second coating composed of from 0.1 to 2% by weight, based on the expandable styrene polymer, of one of the above-described coating formulations according to the invention.

The coatings can also be applied in a coating step to the starting material.

The expandable particulate styrene polymer preferably composed of styrene polymers comprising blowing agent, examples being polystyrene (PS), styrene copolymers such as styrene-acrylonitrile (SAN), styrene-butadiene block copolymers, and mixtures thereof.

An expandable particulate styrene polymer is a material that can be formed, for example by using hot air or steam, to give expanded particulate styrene polymer. It generally comprises amounts of from 2 to 10% by weight, preferably from 3 to 7% by weight, based on the styrene polymer, of chemical or physical blowing agents.

Preferred physical blowing agents are gases such as nitrogen or carbon dioxide or aliphatic hydrocarbons having from 2 to 7 carbon atoms, alcohols, ketones, ethers, or halogenated hydrocarbons. Particular preference is given to use of isobutane, n-butane, isopentane, n-pentane, neopentane, hexane, or a mixture thereof.

The expandable particulate styrene polymer can moreover comprise effective amounts of conventional auxiliaries, such as dyes, pigments, fillers, IR absorbers, e.g. carbon black, aluminum, or graphite, stabilizers, flame retardants, such as hexabromocyclododecane (HBCD), flame retardant synergists, such as dicumyl or dicumyl peroxide, nucleating agents, or lubricants.

The inventive, expandable particulate styrene polymer can, as a function of the production process, be spherical or bead-shaped or cylinder-shaped, and its average particle diameter is generally in the range from 0.05 to 5 mm, in particular from 0.3 to 2.5 mm, and sieving can be used, if appropriate, to divide it into separate fractions.

As a function of the degree of expansion, the average particle diameter of the expanded particulate styrene polymer is in the range from 1 to 10 mm, in particular from 2 to 6 mm, and its density is in the range from 10 to 200 kg/m³.

The expandable particulate styrene polymer can by way of example be obtained via pressure-impregnation of thermoplastic particulate polymer with blowing agents in a tank, via suspension polymerization in the presence of blowing agents, or via melt-impregnation in an extruder or static mixer and then pressurized underwater pelletization.

Expanded particulate styrene polymer can be obtained via foaming of expandable particulate styrene polymer, e.g. using hot air or steam, in pressure-prefoamers, via pressure-impregnation of particulate styrene polymer with blowing agents in a tank and then depressurization, or via melt-extrusion of a melt comprising blowing agent, with foaming and then pelletization. In general the expandable styrene polymers coated with the inventive coating composition can be foamed to lower bulk densities under comparable prefoaming conditions in comparison to conventional coatings. The bulk densities on single prefoaming are in general in the range from 10 to 20 kg/m³, preferably in the range from 15 to 18 kg/m³.

The coating of the expandable or expanded, particulate styrene polymer can take place prior to or after the foaming process, for example via application of the inventive coating formulation in a paddle mixer (Lödige), or via contact of the surface of the particulate styrene polymer with a solution, for example via immersion or spraying. In the case of production via extrusion of a melt comprising blowing agent, the coating-composition formulation can also be added to the water circuit of the underwater pelletizer in the form of an aqueous solution or aqueous suspension.

The inventive expandable particulate styrene polymer has antistatic modification, and exhibits little tendency toward caking during prefoaming, but gives good fusion during foaming to give moldings. Very short depressurization times can be achieved here when the prefoamed particulate material is sintered to give foam moldings with high compressive strength and with high flexural strength. In comparison to conventional coatings, therefore, desired flexural strengths can be achieved for the moldings in conjunction with shorter demolding times. Owing to the effective fusion, even large moldings exhibit homogeneous compressive strength and flexural strength in the marginal and outer regions, and a visibly smoother surface.

### EXAMPLES

### Inventive Examples 1 to 4

### Coating-Composition Formulation:

Hydrogenated castor oil (HCO, m.p.=87° C., (castor Wax NF, CasChem)) was milled with the aid of dry ice to give powder. The ground hydrogenated castor oil was mixed with silicate (SIPERNAT FK320®), glycerol monostearate (GMS, GMSR, Danisco), and glycerol tristearate (GTS, Tegin BI159V, Goldschmitt) to give a uniform powder corresponding to the mixing ratios stated in Table 1.

The coatings were applied in a Lödige mixer (2.5 kg) to the expandable polystyrene beads (Styropor® F215 from BASF Aktiengesellschaft) which had been precoated with antistatic agent 743 (BASF SE) (150 ppm, first coating). The amount of the coating composition (2nd coating), based on the coated, expandable polystyrene beads, is likewise stated in Table 2.

The coated EPS beads were prefoamed in a prefoamer and sintered in a mold to give slabs whose density was 17 or 24 g/l.

Compressive strength was determined at 10% compression to EN 826, and flexural strength was determined to EN12039, Method B.

### Comparative Examples C1 and C2

The procedure was analogous to inventive example 1 and 2, but glycerol monostearate (GMS) was used instead of hydrogenated castor oil.

TABLE 1

| | | | | | Comparative | |
|---|---|---|---|---|---|---|
| | Inv. | Inv. | Inv. | Inv. | examples | |
| | Ex. 1 | Ex. 2 | Ex. 3 | Ex. 4 | C1 | C2 |
| Coating-composition | | | | | | |
| formulation | | | | | | |
| GTS [% by weight] | 40 | 40 | 20 | 20 | 40 | 40 |
| HCO [% by weight] | 45 | 45 | 45 | 45 | 0 | 0 |
| Silicate [% by weight] | 15 | 15 | 15 | 15 | 10 | 10 |
| GMS [% by weight] | 0 | 0 | 20 | 20 | 50 | 50 |
| Amount of coating | 0.4 | 0.4 | 0.3 | 0.3 | 0.45 | 0.45 |
| composition | | | | | | |
| [% by weight] | | | | | | |
| Molding | | | | | | |
| Steam pressure applied | 0.6 | 0.7 | 0.6 | 0.7 | 0.6 | 0.7 |
| [bar] | | | | | | |
| Density [g/l] | 15.9 | 15.7 | 16.4 | 17.1 | 15.1 | 15.8 |
| Compressive strength | 90.7 | 90.1 | 93.7 | 96.8 | 88.4 | 91.6 |
| [kPa] | | | | | | |
| Flexural strength [kPa] | 175 | 186 | 158.5 | 176.6 | 142.2 | 171.8 |
| Demolding time [sec] | 43 | 143.5 | 33.0 | 130 | 45.5 | 172.5 |

### Inventive Examples 5 to 8

### Coating Formulation:

Hydrogenated castor oil (HCO, m.p.=87° C., (HCO Powder, Jayant Oil and derivatives Ltd.) was mixed with silicate (SIPERNAT FK320®), glycerol monostearate (GMS, GMSR, Danisco) and glycerol tristearate (GTS, Tegin BI159V, Goldschmitt) and also zinc stearate to give a uniform powder corresponding to the mixing ratios stated in Table 2.

The coatings were applied in a Lödige mixer (2.5 kg) to the expandable polystyrene beads (Neopor® X5300 from BASF SE) which had been precoated with antistatic agent 743 (BASF SE) (150 ppm). The amount of the coating composition, based on the coated, expandable polystyrene beads, is likewise stated in Table 2.

The coated EPS beads were prefoamed in a prefoamer and sintered in a mold to give slabs whose density was 17 g/l.

Compressive strength was determined at 10% compression to EN 826, and flexural strength was determined to EN12039, Method B.

### Comparative Examples C3 and C4

In this case, typical coatings, without hydrogenated castor oil, were used.

TABLE 2

| | | | | | Comparative | |
|---|---|---|---|---|---|---|
| | Inv. | Inv. | Inv. | Inv. | examples | |
| | Ex. 5 | Ex. 6 | Ex. 7 | Ex. 8 | C3 | C4 |
| Coating-composition | | | | | | |
| formulation | | | | | | |
| GTS [% by weight] | 40 | 40 | 45 | 45 | 73 | 73 |
| HCO [% by weight] | 40 | 40 | 40 | 40 | 0 | 0 |
| Zinc stearate [% by | 10 | 10 | 5 | 5 | 9 | 9 |
| weight] | | | | | | |
| Silicate [% by weight] | 0 | 0 | 0 | 0 | 4 | 4 |
| GMS [% by weight] | 10 | 10 | 10 | 10 | 14 | 14 |
| Amount of coating | 0.5 | 0.5 | 0.5 | 0.5 | 0.5 | 0.5 |
| composition | | | | | | |
| [% by weight] | | | | | | |
| Molding | | | | | | |
| Steam pressure applied | 0.6 | 1.0 | 0.6 | 1.0 | 0.6 | 1.0 |
| [bar] | | | | | | |
| Density [g/l] | 17.2 | 17.0 | 18.7 | 18.3 | 17.5 | 17.0 |
| Compressive strength | 97.5 | 84.9 | 108 | 95 | 99 | 83.6 |
| [kPa] | | | | | | |
| Flexural strength [kPa] | 215 | 204 | 237 | 223 | 211 | 196 |
| Demolding time [sec] | 68 | 145 | 97 | 147 | 27 | 133 |
| Bulk density after 1st | 17.1 | 17.1 | 17.5 | 17.5 | 17.0 | 17.0 |
| foaming operation [g/l] | | | | | | |

### Inventive Examples 9 to 11

### Coating Formulation:

Hydrogenated castor oil (HCO, m.p.=87° C., (HCO Powder, Jayant Oil and derivatives Ltd.) was mixed with silicate (SIPERNAT FK320®), glycerol monostearate (GMS, GMSR, Danisco) and glycerol tristearate (GTS, Tegin BI159V, Goldschmitt) and also zinc stearate to give a uniform powder corresponding to the mixing ratios stated in Table 3.

The coatings were applied in a Lödige mixer (2.5 kg) to the expandable polystyrene beads (Styropor® P426 from BASF SE) which had been precoated with antistatic agent 743 (BASF SE) (150 ppm). The amount of the coating composition, based on the coated, expandable polystyrene beads, is likewise stated in Table 3.

The coated EPS beads were prefoamed in a prefoamer and sintered in a mold to give slabs whose density was 24 g/l.

Compressive strength was determined at 10% compression to EN 826, and flexural strength was determined to EN12039, Method B.

### Comparative Examples C3 and C4

In this case, typical coatings, without hydrogenated castor oil, were used.

TABLE 3

| | | | | Comparative | | |
|---|---|---|---|---|---|---|
| | Inv. | Inv. | Inv. | examples | | |
| | Ex. 9 | Ex. 10 | Ex. 11 | C5 | C6 | C7 |
| Coating-composition | | | | | | |
| formulation | | | | | | |
| GTS [% by weight] | 35 | 35 | 35 | 60 | 60 | 60 |
| HCO [% by weight] | 45 | 45 | 45 | 0 | 0 | 0 |
| Silicate [% by weight] | 15 | 15 | 15 | 10 | 10 | 10 |
| GMS [% by weight] | 5 | 5 | 5 | 30 | 30 | 30 |
| Amount of coating [% | 0.35 | 0.35 | 0.35 | 0.35 | 0.35 | 0.35 |
| by weight] | | | | | | |
| Molding | | | | | | |
| Steam pressure | 0.8 | 1.0 | 1.2 | 0.8 | 1.0 | 1.2 |
| applied [bar] | | | | | | |
| Density [g/l] | 23.5 | 23.5 | 23.5 | 22.3 | 22.5 | 22.5 |
| Compressive strength | 162 | 154 | 146 | 154 | 138 | 133 |
| [kPa] | | | | | | |
| Flexural strength [kPa] | 793 | 805 | 785 | 715 | 744 | 734 |
| Demolding time [sec] | 27 | 115 | 146 | 21 | 113 | 130 |

1. A coating-composition formulation for expandable particulate styrene polymer, comprising
(A) from 10 to 90% by weight of a tristearyl ester whose melting point is in the range from 60 to 65° C.,
(B) from 10 to 90% by weight of a triglyceride of a hydroxy-C₁₆-C₁₈ oleic acid whose melting point is in the range from 70 to 95° C.

2. The coating-composition formulation for expandable particulate styrene polymer, according to claim 1, which is essentially composed of
(A) from 20 to 80% by weight of a tristearyl ester whose melting point is in the range from 60 to 65° C.,
(B) from 15 to 50% by weight of a triglyceride of a hydroxy-C₁₆-C₁₈ fatty acid whose melting point is in the range from 70 to 95° C.,
(C) from 5 to 30% by weight of a hydrophilic or hydrophobic silicate,
(D) from 0 to 40% by weight of a glycerol monoester of a C₁₆-C₁₈ fatty acid,
(E) from 0 to 10% by weight of a quaternary ammonium salt, sulfonium salt or ethylenebisstearyldiamide,
the entirety of components (A) to (E) being 100% by weight.

3. The coating-composition formulation for expandable particulate styrene polymer, according to claim 1, wherein glycerol tristearate (GTS) or tristearyl citrate (CTS) is used as tristearyl ester (A).

4. The coating-composition formulation for expandable particulate styrene polymer, according to claim 1, wherein hydrogenated castor oil (HCO) is used as triglyceride of a hydroxy-C₁₆-C₁₈ oleic acid (B).

5. An expandable particulate styrene polymer, comprising at least one coating which has a coating-composition formulation according to claim 1.

6. The expandable particulate styrene polymer according to claim 5, which has
(I) a first coating composed of from 0.1 to 2% by weight, based on the expandable styrene polymer, of at least one compound from the group comprising glycerol monostearate, glycerol distearate, zinc stearate, quaternary ammonium salts, sulfonium salts, and ethylenebisdiamides, and
(II) a second coating composed of from 0.1 to 2% by weight, based on the expandable styrene polymer, of a coating formulation comprising
(A) from 10 to 90% by weight of a tristearyl ester whose melting point is in the range from 60 to 65° C.,
(B) from 10 to 90% by weight of a triglyceride of a hydroxy-C₁₆-C₁₈ oleic acid whose melting point is in the range from 70 to 95° C.

7. The coating-composition formulation for expandable particulate styrene polymer, according to claim 2, wherein glycerol tristearate (GTS) or tristearyl citrate (CTS) is used as tristearyl ester (A).

8. The coating-composition formulation for expandable particulate styrene polymer, according to claim 2, wherein hydrogenated castor oil (HCO) is used as triglyceride of a hydroxy-C₁₆-C₁₈ oleic acid (B).

9. An expandable particulate styrene polymer, comprising at least one coating which has a coating-composition formulation according to any of claim 2.

10. An expandable particulate styrene polymer, comprising at least one coating which has a coating-composition formulation according to any of claim 3.

11. An expandable particulate styrene polymer, comprising at least one coating which has a coating-composition formulation according to any of claim 4.

12. The expandable particulate styrene polymer according to claim 5, which has
(I) a first coating composed of from 0.1 to 2% by weight, based on the expandable styrene polymer, of at least one compound from the group comprising glycerol monostearate, glycerol distearate, zinc stearate, quaternary ammonium salts, sulfonium salts, and ethylenebisdiamides, and
(II) a second coating composed of from 0.1 to 2% by weight, based on the expandable styrene polymer, of a coating formulation which is essentially composed of:
(A) from 20 to 80% by weight of a tristearyl ester whose melting point is in the range from 60 to 65° C.,
(B) from 15 to 50% by weight of a triglyceride of a hydroxy-C₁₆-C₁₈ fatty acid whose melting point is in the range from 70 to 95° C.,
(C) from 5 to 30% by weight of a hydrophilic or hydrophobic silicate,
(D) from 0 to 40% by weight of a glycerol monoester of a C₁₆-C₁₈ fatty acid,
(E) from 0 to 10% by weight of a quaternary ammonium salt, sulfonium salt or ethylenebisstearyldiamide,
the entirety of components (A) to (E) being 100% by weight.

13. The expandable particulate styrene polymer according to claim 5, which has
(I) a first coating composed of from 0.1 to 2% by weight, based on the expandable styrene polymer, of at least one compound from the group comprising glycerol monostearate, glycerol distearate, zinc stearate, quaternary ammonium salts, sulfonium salts, and ethylenebisdiamides, and
(II) a second coating composed of from 0.1 to 2% by weight, based on the expandable styrene polymer, of a coating formulation which is essentially composed of:
(A) from 20 to 80% by weight of a tristearyl ester whose melting point is in the range from 60 to 65° C.,
(B) from 15 to 50% by weight of a triglyceride of a hydroxy-C₁₆-C₁₈ fatty acid whose melting point is in the range from 70 to 95° C.,
(C) from 5 to 30% by weight of a hydrophilic or hydrophobic silicate,
(D) from 0 to 40% by weight of a glycerol monoester of a C₁₆-C₁₈ fatty acid,
(E) from 0 to 10% by weight of a quaternary ammonium salt, sulfonium salt or ethylenebisstearyldiamide,
the entirety of components (A) to (E) being 100% by weight,
wherein glycerol tristearate (GTS) or tristearyl citrate (CTS) is used as tristearyl ester (A).
